(19) United States
(12) Patent Application Publication
(10) Pub. No.: US 2004/0146019 A1
(43) Pub. Date: Jul. 29, 2004

(54) Methods for controlling random access to prevent collision between uplink messages in a mobile communication system

(75) Inventors: Soeng-Hun Kim, Suwon-si (KR); Kook-Heui Lee, Yongin-si (KR); Sung-Ho Choi, Suwon-si (KR)

Correspondence Address: Paul J. Farrell, DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/756,075

(22) Filed: Jan. 12, 2004

(30) Foreign Application Priority Data
Jan. 10, 2003 (KR) 1736-2003

(51) Int. Cl. H04Q 7/00; H04Q 7/28

(52) U.S. Cl. 370/329; 370/341

(57) ABSTRACT

A method for controlling random accesses of user equipments (UEs) in a mobile communication system. The mobile communication system includes Node-Bs for performing radio communication with the UEs located in a number of cells, a radio network controller (RNC) for controlling the Node-Bs and a service node for connecting the RNC to a core network (CN), and transmits broadcast/multicast service data from the CN to the UEs through the RNC. The service node provides information indicating the number of UEs associated with group signaling to the RNC that controls packet data service for the UEs. When the UEs respond to the group signaling, the RNC refers to the number of UEs associated with the group signaling located in a specific cell, calculates a back-off window value indicating a back-off range necessary for controlling the random accesses of the UEs, contains the calculated back-off window value in a group signaling message, and transmits the group signaling message to the UEs. The UEs randomly select a back-off value within a range based upon the back-off window value in response to the group signaling message, respectively. The UEs wait for a time period corresponding to the randomly selected back-off value, and transmit a response message to the group signaling message to the RNC through a random access channel (RACH), respectively. Therefore, collision and congestion of radio messages due to simultaneous radio accesses of a plurality of UEs can be mitigated.

### PRIORITY

This application claims priority to an application entitled “METHODS FOR CONTROLLING RANDOM ACCESS TO PREVENT COLLISION BETWEEN UPLINK MESSAGES IN MOBILE COMMUNICATION SYSTEM”, filed in the Korean Intellectual Property Office on Jan. 10, 2003 and assigned Serial No. 2003-1736, the contents of which are hereby incorporated by reference.

### BACKGROUND OF THE INVENTION

1. Field of the Invention

The present invention relates to a mobile communication system, and more particularly to methods for effectively providing information of transmission time intervals for uplink messages to prevent a collision destructive between the messages when a plurality of user equipments (UEs) simultaneously transmit uplink messages through a random access channel (RACH).

2. Description of the Related Art

In a communication system based on a conventional general packet radio service (GPRS), a plurality of user equipments (UEs) can use a random access channel (RACH) to transmit uplink data. Conventionally, random access is performed to initiate an arbitrary transmission operation when the UEs generate data, without being under the control of the system. Such random access enables a transmission band to be efficiently and practically used without a concentrated channel monitoring operation by the system.

In multimedia broadcast/multicast service (MBMS) in which a plurality of UEs frequently transmit messages through the RACH at the same time, effective management of the RACH is very important.

“MBMS” refers to a service in which the same multimedia data is transmitted to a plurality of receivers through a radio network.

FIG. 1 is a schematic block diagram illustrating system components for supporting multimedia broadcast/multicast service (MBMS). User equipments (UEs) 161, 162, 163, 171 and 172 indicate user terminals, i.e., subscribers, capable of receiving the MBMS. The first Node-B 160 and the second node-B 170 are connected to the UEs through radio channels, and are base stations (BSs) for transmitting MBMS-related data. A radio network controller (RNC) 140 is a base station controller (BSC) for controlling a plurality of BSs. The RNC 140 performs a function of selectively transmitting multimedia data to a specified cell and a function of controlling the radio channels set to provide the MBMS. The RNC 140 and the Node-Bs 160 and 170 form a radio access network (RAN).

A serving GPRS support node (SGSN) 130 performs a function of controlling MBMS-related service for the subscribers. For example, the SGSN 130 performs a function of managing service billing-related data of each subscriber, a function of selectively transmitting MBMS data to the specific RAN 140, etc. A transit network (NW) 120 performs a function of providing a communication path between a multicast/broadcast service center (MB-SC) 110 and the SGSN 130. The transit NW 120 can include a gateway GPRS support node (GGSN) (not shown) and an external network. The MB-SC 110 is a source of MBMS data and is responsible for scheduling the data. A home location register (HLR), not shown in FIG. 1, is connected to the SGSN 130, and performs a function of authenticating each subscriber.

As shown in FIG. 1, an MBMS data stream is transferred to the UEs 161, 162, 163, 171 and 172 via the transit NW 120, the SGSN 130, the RNC 140 and the Node-Bs 160 and 170. A plurality of SGSNs 130 and a plurality of RNCs 140 corresponding to each SGSN 130 (not shown in FIG. 1) can exist for one MBMS service. Furthermore, the SGSN 130 must be able to perform a function of selectively transmitting data to the RNC 140, and the RNC 140 must be able to perform a function of selectively transmitting data to the Node-Bs 160 and 170. For this, the SGSN 130 and the RNC 140 store a list of RNCs and a list of Node-Bs as lists of lower network elements to receive the data stream, respectively. Then, the SGSN 130 and the RNC 140 selectively transmit the MBMS data only through at least one network element listed in the stored list, respectively.

An operation between the subscriber and the network for providing a specific MBMS service will be described. Here, CN denotes a core network consisting of an SGSN, a transit NW, an MB-SC, a GGSN, etc. The SGSN of the above-described elements is directly coupled to the RNC.

UEs perform a service subscription procedure through a service provider for providing an MBMS multicast service, respectively. When the CN provides a specific service of the MBMS, the service provider makes a service announcement to the UEs subscribed for the MBMS. At this time, the UEs perform a joining procedure for joining a subscriber group to receive a corresponding MBMS service. Then, the CN assigns network resources necessary for transmitting MBMS data to a multicast area. At this point, the UEs are notified of the fact that data relating to the MBMS service for which they have subscribed through the MBMS service announcement will be transferred. Then, the MBMS data is transferred to the UEs. When the MBMS data is no longer generated, the resources for transferring the MBMS data are released.

An operation for enabling the CN to provide the MBMS service to the UEs will be described in detail with reference to FIG. 2. The CN includes the SGSN, the transit NW and the MB-SC shown in FIG. 2, but the operation will be described mainly with reference to the SGSN.

Upon recognizing basic information for a specific MBMS service through the announcement at step 200, a UE transmits an ACTIVATE MBMS PDP CONTEXT REQUEST message to the SGSN in order to join a desired MBMS service at step 201. This operation is performed in order to activate a packet data protocol (PDP) context storing a subscriber profile necessary to use the MBMS service.

If the UE has first made a service request, the SGSN receiving the message configures and stores the MBMS PDP context for the UE. The SGSN performs a tunnel setup based on a GPRS tunneling protocol (GTP) with the GGSN, notifies the GGSN of service-related information, and exchanges logical identifiers with the GGSN. Details of the GTP tunnel setup are described in the 3rd Generation Partnership Project (3GPP) Technical Specification (TS) 23.060. The MBMS PDP context is a set of variables containing information associated with a specific service of the MBMS. Furthermore, the MBMS PDP context can contain a list of UEs requesting that the MBMS PDP context be activated, UE location information (or RNC identifiers), information relating to transport bearers for transmitting corresponding MBMS data, etc. At step 202, the SGSN transmits, to the UE, an ACTIVATE MBMS PDP CONTEXT ACCEPT message indicating that the joining operation has been completed.

Just before an MBMS service initiation or upon receiving the first MBMS data, the SGSN calls the UEs desiring to receive the MBMS, i.e., the UEs requesting that the PDP context be activated, through a notification procedure. The notification procedure will be described below.

At step 203, when the SGSN transmits a NOTIFICATION message to the RNC the cells to receive the NOTIFICATION message are cells in which the UEs performing the joining procedure at the above steps 201 and 202 are located.

At step 204, the RNC recognizes a list of UEs in the connected mode located in lower cells, and recognizes cells corresponding to a related RA. Thus, the RNC determines which cells will receive the NOTIFICATION message. Then, the RNC transmits the NOTIFICATION message to the determined cells. The NOTIFICATION message at the above step 204 includes an identity (ID) of the MBMS service to be provided. The UEs receiving the NOTIFICATION message refers to the MBMS service ID and can determine whether or not the MBMS service to be provided must be initiated.

The NOTIFICATION message is used for group signaling that enables a plurality of UEs to receive one message. That is, when n number of UEs desires to receive the MBMS service data from a cell receiving the NOTIFICATION message, the number of UEs to respond to the NOTIFICATION message is “n”. After transmitting the NOTIFICATION message, the RNC waits to receive responses to the NOTIFICATION message while monitoring random access channels (RACHs).

At step 205, the UEs transmit a NOTIFICATION RESPONSE message to the SGSN through the RNC in order to commit to MBMS service reception or in order to notify the SGSN of the fact that the NOTIFICATION message has been received. The NOTIFICATION RESPONSE message can contain an MBMS service ID. Because the NOTIFICATION RESPONSE message is a response to the group signaling, the plurality of UEs may simultaneously generate NOTIFICATION RESPONSE messages.

Among the UEs receiving the NOTIFICATION message, some UEs in the Cell_FACH/Cell_PCH/URA_PCH state or the idle mode, without the uplink dedicated channel, transmit the NOTIFICATION RESPONSE messages through the common uplink channel serving as the RACH. The RACH is described in 3GPP TS 25.331, TS 25.214, TS 25.321, etc.

The SGSN collects the NOTIFICATION RESPONSE messages transmitted from the UEs, and updates lists in the MBMS PDP context. The lists contain a list of UEs operating in the connected mode on an RNC-by-RNC basis and committed to a corresponding MBMS service reception, and a list of UEs operating in the idle mode on an RA-by-RA basis and committed to the corresponding MBMS service reception.

At step 206, the SGSN transmits an MBMS RB ASSIGNMENT REQUEST message to the RNC. The MBMS RB ASSIGNMENT REQUEST message can contain quality of service (QoS) information required for providing the MBMS service. The RB includes a transport bearer for an Iu interface between the SGSN and the RNC, a transport bearer for an Iub interface between the RNC and the Node-B and another radio interface. Iu interface is an interface between SGSN and RNC, and Iub interface is an interface between RNC and Node-B. Details of Multimedia Broadcast/Multicast Service Architecture and Functional Description state 2 are described in the 3^{rd} Generation Partnership Project (3GPP) Technical Specification (TS) 23.246.

The RNC determines MBMS RB information on a cell-by-cell basis according to the QoS information received at the above step 206. The MBMS RB information includes layer-1 (L1) information and layer-2 (L2) information. The L2information contains information relating to radio link control (RLC)/packet data control protocol (PDCP), etc. and the L1information contains transport format set (TFS) information, transport format combination set (TFCS) information, channelization code information, transmission power-related information, etc.

At step 207, the RNC transmits, to corresponding UEs, the determined MBMS RB information through an MBMS RB SETUP message. Because the MBMS RB SETUP message is a group signaling message, the UEs can simultaneously transmit MBMS RB SETUP COMPLETE messages as responses to MBMS RB SETUP messages at step 208. As the completion of the MBMS RB setup means the completion of an MBMS data transmission preparation, the RNC notifies the SGSN of the fact that the MBMS RB setup has been completed through an MBMS RB ASSIGNMENT RESPONSE message at step 209. The SGSN begins to transfer the MBMS data at step 210.

As described above, a group signaling message (e.g., a NOTIFICATION message or MBMS RB SETUP message) for providing the same information to a plurality of UEs may cause a plurality of response messages to be transmitted at the same time point, and the response messages can be transmitted through the RACH according to operating modes of the UEs.

The RACH transmission operation will be briefly described with reference to FIG. 3. The RACH is a channel for transmitting uplink data that is used by the UEs without using a dedicated channel, i.e., the UEs in the Cell_FACH/Cell_PCH/URA_PCH state or the idle mode. A set of radio resources for transmitting the RACH is as follows.

1. A preamble scrambling code indicates one scrambling code corresponding to a specific RACH. Preambles 311, 312, 313, 314, 321, 322 and 323 and RACH data 315 and 324 are scrambled with a corresponding preamble scrambling code.

2. A signature set indicates orthogonal variable spreading factor (OVSF) codes. A maximum of sixteen OVSF codes having a spreading factor 16 can be assigned to one RACH. The signature set is used for coding the preambles and RACH data.

3. An access slot set is configured by 2 timeslots. A preamble begins to be transmitted at a start time-point of each access slot.

A UE operation associated with the RACH transmission will be described with reference to FIG. 4. FIG. 3 will be further explained in FIG. 4.

When a UE in the idle mode or Cell_PCH/URA_PCH/Cell_FACH state determines that data to be transmitted in an uplink direction is present at step 401, the UE operation proceeds to step 402. The above step 401 corresponds to the case where the UE receives a group signaling message or needs to transmit a location information update message.

Steps 402 to 407 correspond to an RACH transmission operation. UEs are assigned an access service class (ASC) according to a type of data to be transmitted through the RACH at a specific time-point, respectively. The ASC has a corresponding persistence value. The ASC is used for discriminating a transmission manner based upon a type of data stream. Eight ASCs having values of 0 to 7 can exist. Each ASC corresponds to a persistence value, an available signature set and an available access slot set. The above-described information is transmitted to the UEs in advance as system information.

Each UE can have various types of data streams that are transmitted through different radio bearers. For example, the radio bearers can include a radio bearer for transferring a control message and another radio bearer for voice communication. The radio bearers are set up through the radio bearer setup procedure. At this point, the ASCs corresponding to the radio bearers are assigned. At step 401, when uplink data to be transmitted is generated, the UE recognizes the ASC corresponding to the radio bearer for transmitting the data.

At step 402, the UE performs a persistence value test, i.e., a “p” test, using a persistence value of a corresponding ASC associated with the generated data stream. The persistence value is a real number between 0 and 1, and means the probability of success of the persistence value test. That is, a persistence value of 0.5 indicates that the probability of success of the persistence value test is 50%. If the persistence value test is successful, step 403 is performed. On the other hand, if the persistence value test is unsuccessful, the UE waits for 10 ms and then re-performs the persistence value test.

At step 403, the UE transmits an RACH preamble. At this time, the UE randomly selects one of available signatures corresponding to the ASC, codes the RACH preamble using the randomly selected signature, and transmits the coded RACH preamble with predetermined initial transmission power. Because the setup of the initial transmission power is described in detail in 3GPP TS 25.331, its description will be omitted here.

At step 404, the UE monitors an acquisition indication channel (AICH). The Node-B notifies the UE transmitting a specific preamble of the fact that the preamble signal has been successfully received, through the AICH. Simultaneously, the AICH is used to transmit an acknowledge (ACK) or non-acknowledge (NACK) signal for allowing a message to be transmitted through the RACH.

If no response is recognized through the AICH, the UE proceeds to step 406. At step 406, the UE reselects one of available signatures associated with a corresponding ASC and increments transmission power by a predetermined step size. Then, the UE returns to step 403 so that the RACH preamble is retransmitted using the reselected signature and the incremented transmission power. The UE can increase the probability of enabling the Node-B to recognize the RACH preamble through step 406.

If the ACK signal is detected from the AICH, the UE proceeds to step 405 so that the RACH data can be transmitted. Before the RACH data is transmitted, the UE waits for 3 or 4 time slots. The RACH data is spread by an OVSF code arranged on an OVSF code tree that is the same as an OVSF code tree for the signature of a corresponding preamble.

On the other hand, if the NACK signal is detected from the AICH, the UE proceeds to step 407. After the UE waits for “NBO_{—}1*10 ms”, the UE to step 402 so that the RACH transmission operation is repeated. Here, “NBO_{—}1” denotes a system information value.

The operation in which a plurality of UEs use the common RACH will be described with reference to FIG. 3.

It is assumed that the first UE 310 and the second UE 320 use the same RACH and share the same signature set and the same access slot set. The signatures corresponding to an ASC for the first and second UEs 310 and 320 include 9 signatures of [S1, . . . , S9]. Here, no consideration is given to the access slots.

When the first UE 310 transmits the preamble 311 using a signature S1 but does not receive the ACK or NACK signal, it transmits the preamble 312 using a newly selected signature S2 at transmission power incremented by the step size. Similarly, where the first UE 310 does not receive a response to the signature S2 from the AICH, it transmits the preamble 313 or 314 using the signature S4 or S9 at the transmission power further incremented by the step size. When the Node-B 350 does not receive the preambles 311, 312 and 313 and receives the preamble 314, it transmits an ACK signal 341 associated with the signature S9 through the AICH.

Similarly, the second UE 320 transmits the preambles 321, 322 and 323 while incrementing the transmission power, and receives the ACK signal 341 to the preamble 323 through the AICH.

Where at least two UEs 310 and 320 select the same signature S9 and transmit the preambles 314 and 323 at the same time, the first and second UEs 310 and 320 detect the ACK signal 341 from the AICH as the response to the preambles 314 and 323, and begin to transfer the RACH data 315 and 324, respectively.

As described above, since the RACH data uses an OVSF code arranged on the OVSF code tree that is the same as the OVSF code tree for the signature corresponding to the ACK signal, there is no orthogonality between the RACH data 315 and the RACH data 324. Thus, the Node-B cannot correctly discriminate between the RACH data 315 and the RACH data 324.

Where a plurality of UEs select the same signature at the same time, the probability of an RACH signal transmission failing increases, and uplink interference can increase because at least two UEs perform a transmission operation at the same time.

That is, where conventional uplink messages as in the RACH signal transmission are simultaneously transmitted by the plurality of UEs, there is a problem in that a collision between the uplink messages can be incurred.

This problem can be more significant in performing the MBMS in which the plurality of UEs transmit RACH signals based upon one group signaling message at the same time.

### SUMMARY OF THE INVENTION

Therefore, the present invention has been made in view of the above problems, and it is an object of the present invention to provide a random access method for preventing an incurable collision when a plurality of user equipments (UEs) simultaneously transmit predetermined uplink messages through a common random access channel (RACH) in a mobile communication system.

It is another object of the present invention to provide an efficient random access method for distributing back-off values for random accesses of a plurality of user equipments (UEs) while considering the number of UEs and the capacity of a random access channel (RACH).

It is another object of the present invention to provide a method for enabling a radio network controller (RNC) transmitting a group signaling message to a plurality of user equipments (UEs) to provide information of transmission time intervals for uplink response messages on a cell-by-cell basis in a mobile communication system that provides a multimedia broadcast/multicast service (MBMS).

It is another object of the present invention to provide a method for enabling a plurality of user equipments (UEs) to efficiently transmit uplink response messages to a group signaling message in a mobile communication system that provides a multimedia broadcast/multicast service (MBMS).

It is yet another object of the present invention to provide a method for efficiently deciding transmission time intervals for uplink response messages in a mobile communication system that provides a multimedia broadcast/multicast service (MBMS).

In accordance with a first aspect of the present invention, the above and other objects can be accomplished by the provision of a method for enabling a radio network controller (RNC) to control random accesses of user equipments (UEs) to a mobile communication system when the UEs need to respond to one group signaling message, the mobile communication system including Node-Bs for performing radio communication with the UEs located in a number of cells, the RNC controlling the Node-Bs and a service node connecting the RNC to a core network (CN), and transmitting broadcast/multicast service data from the CN to the UEs through the RNC, said method comprising the steps of: receiving information indicating the number of UEs associated with group signaling from the service node; when group signaling is required, calculating a back-off window value by referring to the number of UEs, the back-off window value indicating a back-off range necessary for controlling the random accesses of the UEs; and containing the calculated back-off window value in a group signaling message and transmitting the group signaling message to the UEs so that simultaneous random accesses of the UEs performed as responses to the group signaling can be prevented.

In accordance with a second aspect of the present invention, the above and other objects can be accomplished by the provision of a method for enabling user equipments (UEs) to perform random accesses to a mobile communication system when the UEs need to respond to one group signaling message, the mobile communication system including Node-Bs for performing radio communication with the UEs located in a number of cells, a radio network controller (RNC) controlling the Node-Bs and a service node connecting the RNC to a core network (CN), and transmitting broadcast/multicast service data from the CN to the UEs through the RNC, said method comprising the steps of: receiving the group signaling message containing a predetermined back-off window value determined according to each of the cells in which the UEs are located; when it is determined that a response to the group signaling message is required, randomly selecting a back-off value within a range based upon the back-off window value; and waiting for a time period corresponding to the randomly selected back-off value, and transmitting a response message to the group signaling message through a random access channel.

In accordance with the third aspect of the present invention, the above and other objects can be accomplished by the provision of a method for enabling user equipments (UEs) to perform random accesses to a mobile communication system when the UEs need to respond to one group signaling message, in the mobile communication system including Node-Bs for performing radio communication with the UEs located in a number of cells, a radio network controller (RNC) for controlling the Node-Bs and a service node for connecting the RNC to a core network (CN), and transmitting broadcast/multicast service data from the CN to the UEs through the RNC, said method comprising the steps of: providing information indicating the number of UEs associated with group signaling from the service node to the RNC; when the group signaling is required, allowing the RNC controlling a packet data service for the UEs to refer to the number of UEs associated with the group signaling located in a specific cell and an amount of resources assignable for random access in the cell, and to calculate a back-off window value indicating a back-off range necessary for controlling the random accesses of the UEs; transmitting a group signaling message containing the calculated back-off window value from the RNC to the UEs; allowing the UEs to randomly select a back-off value within a range based upon the back-off window value in response to the group signaling message, respectively; and allowing the UEs to wait for a time period corresponding to the randomly selected back-off value, and to transmit a response message to the group signaling message to the RNC through a random access channel, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram illustrating the architecture of a conventional multimedia broadcast/multicast service (MBMS) system network FIG. 2 is a flow chart illustrating a procedure for exchanging messages in a conventional MBMS;

FIG. 3 is an explanatory view illustrating an example of the case where a plurality of subscribers use a random access channel (RACH) in the conventional MBMS;

FIG. 4 is a flow chart illustrating a conventional operation for transmitting data through the RACH;

FIG. 5 is a flow chart illustrating an operation for transmitting data through the RACH in accordance with the present invention;

FIG. 6 is a flow chart illustrating operations of network components in accordance with an embodiment of the present invention;

FIG. 7 is a flow chart illustrating a procedure for enabling a radio network controller (RNC) to decide a back-off window (BOW) value in accordance with an embodiment of the present invention; and

FIG. 8 is a flow chart illustrating a procedure for exchanging messages in the MBMS in accordance with an embodiment of the present invention.

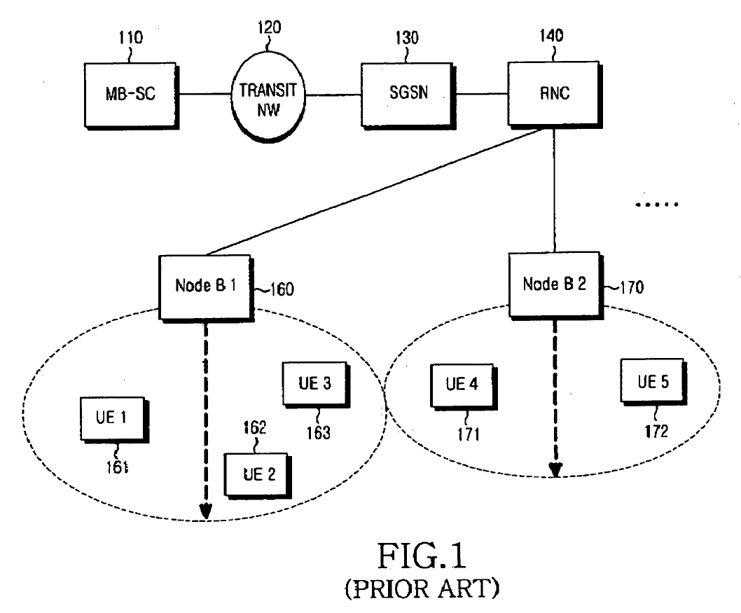

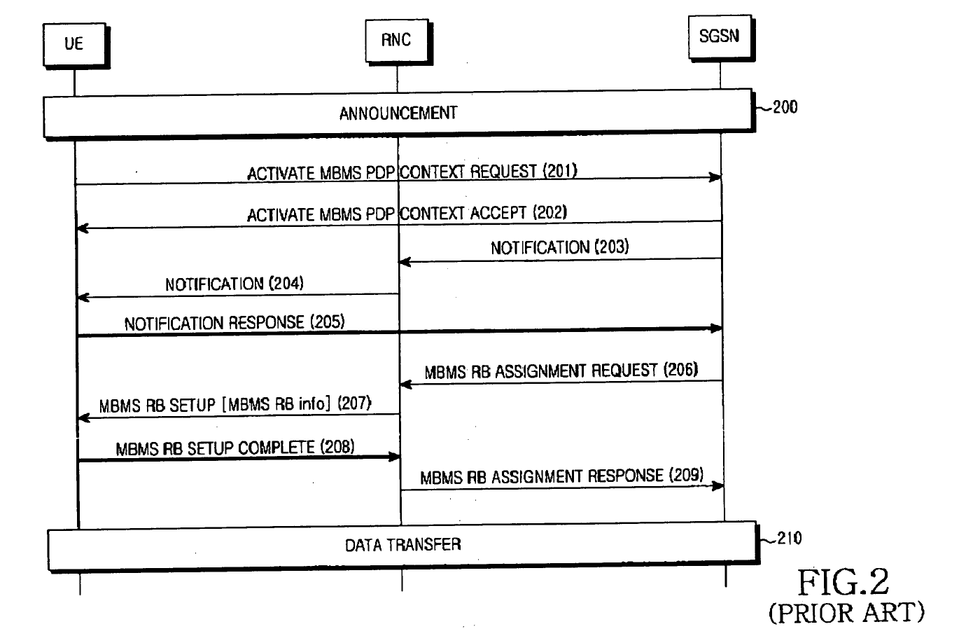

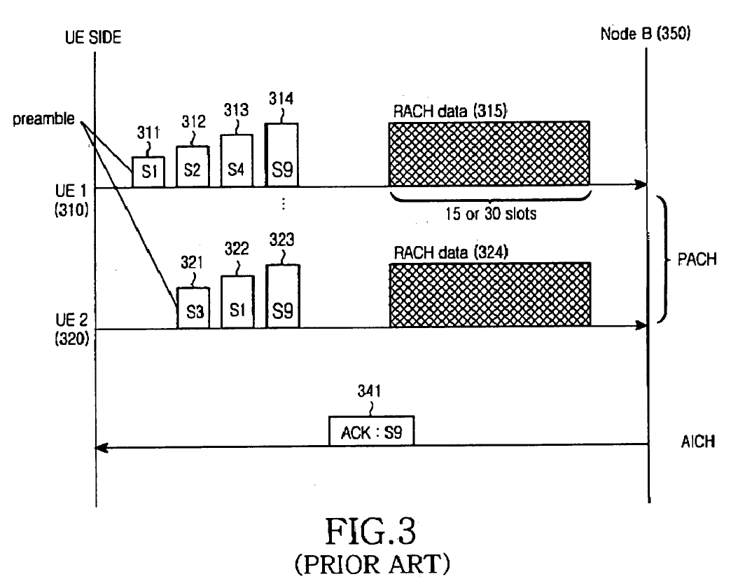

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

The present invention can be applied to any mobile communication system or any communication service that transmits data from user equipments (UEs) in an uplink direction according to a random access manner. In particular, the present invention can be more effectively used in multimedia broadcast/multicast service (MBMS) in which a plurality of UEs frequently transmit messages through random access at the same time.

Thus, the present invention will be described on the basis of the MBMS.

In the preferred embodiment of the present invention to be described below, time points of enabling the plurality of UEs to transmit random access channel (RACH) signals are randomly distributed, and the number of UEs simultaneously transmitting the RACH signals can be reduced. At this time, transmission time points for RACH signals can be distributed according to the number of UEs desiring to receive a specific MBMS service and an available RACH capacity, i.e., an amount of resources. For this, each UE uses a back-off value to decide a time point of random access. Here, the back-off value indicates a standby time before a transmission operation is attempted.

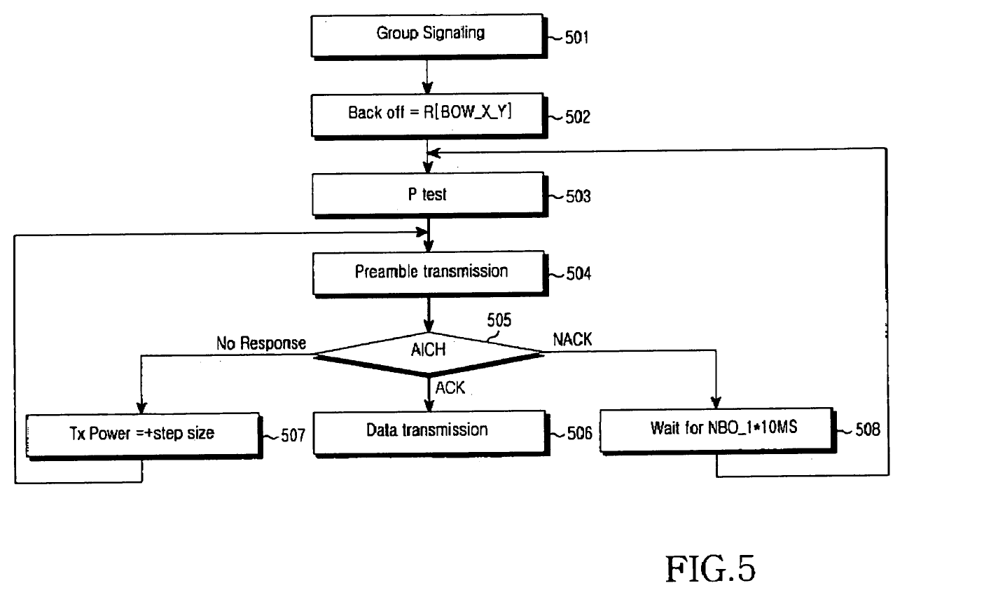

The operation in accordance with the preferred embodiment of the present invention will be described in detail with reference to FIGS. 5 to 8.

When the number of UEs joining an MBMS service Y in a cell X is denoted by “NO₁₃ UE_X_Y”, it can be found that the UEs corresponding to a “NO_UE_X_Y” value try to transmit RACH signals in the cell X where a radio network controller (RNC) transmits a group signaling message for the MBMS service Y, i.e., a NOTIFICATION message or an MBMS RB SETUP message.

Therefore, the RNC commands the UEs to randomly transmit response messages to the group signaling message, i.e., NOTIFICATION RESPONSE messages or MBMS RB SETUP COMPLETE messages, at appropriate time points, i.e., at predetermined time points depending upon the “NO_UE_X_Y” value. This is implemented by containing a back-off window value in the group signaling message to be transmitted from the RNC to the UEs.

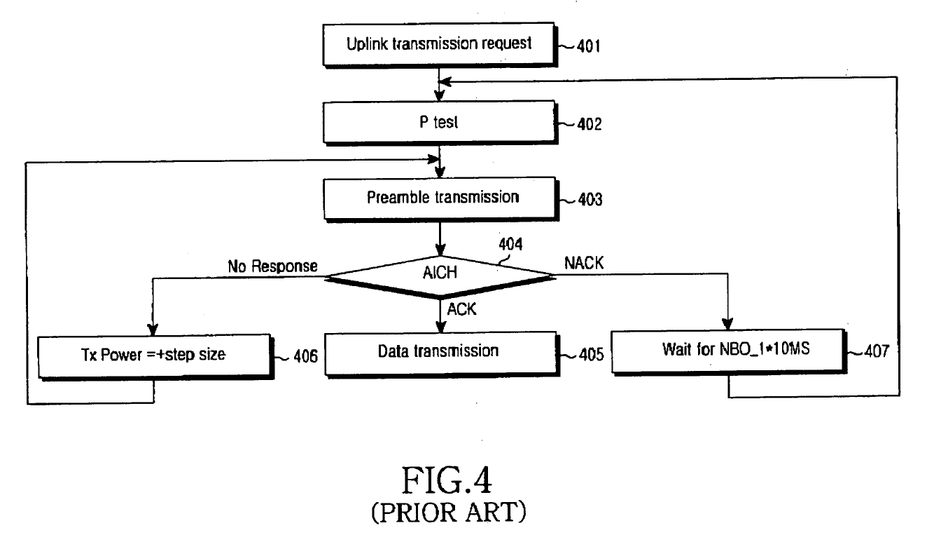

The UE's operation in accordance with the preferred embodiment of the present invention is shown in FIG. 5. When FIG. 5 is compared with FIG. 4, FIG. 5 further includes step 502. Where an uplink signal must be transmitted through the RACH, for example, where a paging message associated with a temporary MBMS group identifier (TMGI) or an MBMS RB SETUP message has been received, the UE waits for a time period corresponding to a back-off value and then begins to transmit an RACH signal. Here, the RACH signal transmission procedure is a procedure for transmitting an arbitrary message through the RACH at steps 502 to 507.

At step 501, the UE in the idle mode or Cell_PCH/URA_PCH/Cell_FACH state receives a group signaling message for the MBMS service Y to be provided, for example, a NOTIFICATION message or an MBMS RB SETUP message. The group signaling message contains a back-off window (BOW) value decided by the RNC. The UE decides a time point of transmitting a group signaling response message using the BOW value. Here, the cell X's BOW value for the MBMS service Y is denoted by “BOW_X_Y”.

The transmission time point corresponds to a value randomly selected from the BOW value. The randomly selected value can prevent the response messages of a plurality of UEs from being transmitted at the same time.

When the “BOW_X Y” value is determined, the following must be considered.

First, the number of UEs to receive the group signaling message and transmit the response messages through the RACH, i.e., the “NO_UE_X_Y” value, must be considered.

Second, available RACH transmission resources of the cell X receiving the group signaling message, i.e., “RACH_RESOURCE_X”, must be considered since RACH transmission resources can be different according to cells.

Equation 1

BOW_{—}X_{—}Y=f(NO_{—}UE _{—}X_{—}Y, RACH_{—}RESOURCE _{—}X)

According to the above Equation 1, the “BOW_X_Y” value is based upon a function “f” associated with “NO UE_X_Y” indicating the number of UEs to transmit the response messages through the cell X and “RACH_RESOURCE_x” indicating the available RACH transmission resources in the cell X. Here, the function “f” can be set by the system.

Where K number of RACHs is used in the cell X, a total amount of RACH resources in the cell X, i.e., RACH_RESOURCE_X shown in the above Equation 1, is given by the following Equation 2.

$$RACH\_RESOURCE \_X = {\sum }_{k = 1}^{k} ( RACH\_RESOURCE \_k ) \qquad Equation 2$$

“RACH_RESOURCE_k” shown in the above Equation 2 denotes the RACH transmission resources assigned to the k^{th} RACH. The RACH transmission resources of “RACH_RESOURCE_k” include signatures, sub-channels and persistence values.

Because the RACH transmission resources are assigned on an ASC-by-ASC basis, the RACH transmission resources assigned to “ASC_i” can be determined by the following Equation 3.

Equation 3

RACH_{—}RESOURCE_{—}ASC_{—}i=f (signature _{—}i, subchannel _{—}i, persistence value _{—}i)

In the above Equation 3, “signature_i” denotes signatures assigned to “ASC_i” and “subchannel_i” denotes sub-channels assigned to “ASC_i”. Here, the sub-channels correspond to an access slot set, and reflect timing information for the RACH resource. Furthermore, “persistence_i” denotes a persistence value assigned to “ASC_i”. A maximum of twelve sub-channels can be present in one system, and a plurality of sub-channels can be assigned in relation to one ASC. The above Equation 3 can be determined by applying the signatures and the access slots and the persistence value assigned to “ASC_i” to an arbitrary function “f”. Here, the function “f” can be set by the system.

Similarly, where H number of ASCs is used, RACH_RESOURCE_k shown in the above Equation 2 is given by the following Equation 4.

$$RACH\_RESOURCE \_k = {\sum }_{i = 1}^{H} ( Weight\_i \times RACH\_RESOURCE \_ASC \_i ) \qquad Equation 4$$

In the above Equation 4, “Weight_i” denotes a weight value given to “ASC_i”, and indicates a ratio based upon “ASC_i” in the total amount of RACH transmission resources required according to the group signaling message. For example, if three of the 10 RACH messages belong to “ASC 1”, and the remaining 7 RACH messages belong to “ASC 2” where 10 RACH messages are generated, “Weight_1” is 0.3, “Weight_2” is 0.7 and other weight values are 0. When the BOW value is calculated, the RNC refers to an RACH use history on an ASC-by-ASC basis and can calculate a weight value of each ASC.

Various elements defining the above-described “RACH_RESOURCE_X” are values recognized by the RNC and can be immediately produced if necessary. The above-described functions are needed to be appropriately defined, and depend upon system states.

The procedure for determining a BOW_X_Y value using specific values will be described below as an example.

Where it is assumed that one RACH is present within cell X and all 8 ASCs of ASC 0 to ASC 7 are configured on the RACH, RACH transmission resources assigned to the ASCs are as follows.

That is, “a” number of the same signatures and “b” number of sub-channels are assigned to each of the ASCs. A persistence value of ASC 0 is “1”, and persistence values of the remaining ASCs are “p”. The weight values of the ASCs are the same as “⅛”. That is, all ASCs are appropriately used.

Where the RACH transmission resources on each ASC, i.e., RACH_RESOURCE_ASC, are defined as the multiplication of the number of signatures, the number of sub-channels and a persistence value of each ASC, RACH_RESOURCE_ASC_{—}0=a*(b/12)*1. Here, “12” is the total number of sub-channels, and “1” is the persistence value of ASC 0. Furthermore, RACH_RESOURCE_ASC_i (where i=1˜7)=a*(b/12)*p.

$$\begin{matrix}Thus , RACH\_RESOURCE = SUM [ i = 0 \sim 7 ] \\ [ Weight\_i * RACH\_RESOURCE \_ASC \_i ] \\ = ( 1 / 8 ) * SUM [ i = 0 \sim 7 ] [ a * ( b / 12 ) * p\_i ] \\ = ( 1 / 8 ) * 8 * a * ( b / 12 ) * [ ( 1 + 7 p ) / 8 ] .\end{matrix}$$

Furthermore, “BOW_X_Y” shown in the above Equation 1 can be concretely expressed as the following Equation 5.

$$BOW\_X \_Y = z \times \frac{NO\_UE \_X \_Y}{RACH\_RESOURCE} \qquad Equation 5$$

In the above Equation 5, it is preferable that “BOW_X_Y” is directly proportional to the number of UEs transmitting messages through the RACH in each cell, and is inversely proportional to available RACH transmission resources on each cell.

In the case of the above-described example, “BOW_X_Y” can be expressed as follows.

BOW_{—}X_{—}Y=z*NO_{—}UE_{—}X_{—}Y/[a*b*(1+7p)/96]

Here, “z” is an arbitrary constant and is a coefficient value necessary for adjusting “BOW_X_Y” to an appropriate magnitude.

Again referring to FIG. 5, the UE produces a back-off value using “BOW_X_Y” received at the above step 501, at step 502. The back-off value is produced as R[BOW_X_Y], and is produced in units of radio frames. R[BOW] is one value selected from integers of 0 to a BOW value having the same selection probability at the above step 502. RACH transmission time points of the UEs receiving the group signaling message for the MBMS service Y are randomly selected during a time period corresponding to values between “0” and the “BOW_X_Y” value. The UE receiving the group signaling message determines that an uplink dedicated channel has not been assigned and then proceeds to step 503 so that a response can be transmitted through the RACH. Before the following steps 503 to 508 are performed, the UE waits for a time period of the number of radio frames corresponding to the back-off value produced at the above step 502.

The above steps 503 to 508 shown in FIG. 5 are the same as the above steps 402 to 407 shown in FIG. 4. That is, at step 503, the UE performs a “p” test using a persistence value of the ASC corresponding to a data stream to be transmitted through the RACH. If the “p” test has been successfully performed, the UE proceeds to step 504. On the other hand, if the “p” test has failed, the UE waits for a predetermined time and then re-performs the “p” test.

At step 504, the UE codes an RACH preamble using one signature selected from available signatures of a corresponding ASC, and transmits the coded preamble with predetermined initial power. At step 505, the UE monitors the AICH. If no response message has been detected, the UE proceeds to step 507. The UE re-selects one of the available signatures of the corresponding ASC, increments the transmission power by a predetermined step size, and returns to step 504. The UE re-transmits the RACH preamble.

If the ACK signal has been detected from the AICH, the UE proceeds to step 506, such that the UE transmits RACH data. On the other hand, if the NACK signal has been detected from the AICH, the UE proceeds to step 508. The UE waits for a time period of “NBO_{—}1*10 ms” and then returns to step 503.

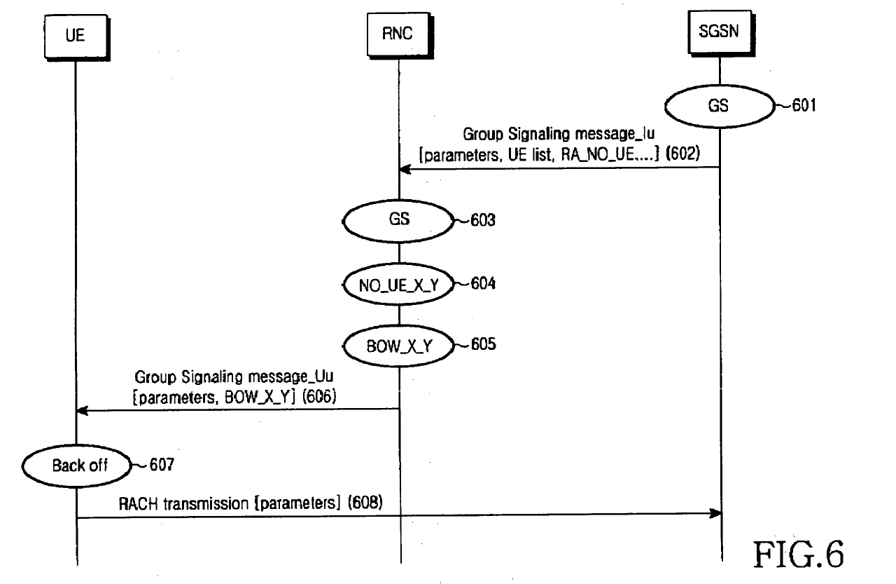

FIG. 6 shows the flow of messages required in the preferred embodiment of the present invention.

Referring to FIG. 6, the SGSN determines, at step 601, whether a group signaling operation must be performed for an MBMS service while the service is provided. For example, when desiring to receive notification responses so that the UEs desiring to receive a specific MBMS service can be recognized, the SGSN transmits a NOTIFICATION message to the RNC through an Iu interface.

A group signaling message generated from the SGSN and transmitted to the RNC through the Iu interface is denoted by a “group signaling message_Iu” 602. The group signaling message_Iu 602 contains the following elements:

1. The group signaling message_Iu 602 contains typical parameters inserted thereinto according to its type and use, for example, an MBMS service identifier and paging cause in the NOTIFICATION message.

2. The group signaling message_Iu 602 contains a list of UEs in a radio resource control (RRC) connected mode associated with the corresponding MBMS service, and the list of UEs is stored in the RNC. If the list of UEs has already been stored, the group signaling message_Iu 602 does not contain the list of UEs.

3. The group signaling message_Iu 602 contains a list of RAs of the RNC at which the UEs in the idle mode associated with the corresponding MBMS service are located and the number of UEs in the idle mode that are located in each RA. The RA is an area associated with location registration update to be performed when the UEs in the idle mode move to a new RA. The RA is comprised of a plurality of cells. The RNC recognizes the relationship between the RA and cells, or recognizes cells comprising a specific RA.

At step 603, the RNC determines whether or not group signaling (GS) must be performed. This determination is performed in the case where the RNC has received the group signaling message_Iu 602 from the SGSN or needs the determination for itself. The former case corresponds to the NOTIFICATION message transmission and the latter case corresponds to a case of changing a radio bearer providing the MBMS.

If the RNC determines that the group signaling is needed as at step 603, the RNC confirms “NO_UE_X_Y” of the cells for the group signalling at step 604. Here, “NO_UE_X_Y” is calculated as a sum of “NO_UE_X_Y_CONNECTED” denoting the number of LEs in the connected mode and “NO_UE_X_Y_IDLE” denoting the number of UEs in the idle mode.

The RNC classifies the UEs contained in the UE list received from the SGSN on a cell-by-cell basis, and regards the number of UEs located in cell X as “NO_X_Y_CONNECTED”.

Furthermore, the RNC estimates a “NO_UE_X_Y_IDLE” value using “RA_NO_UE” received from the SGSN as in the following:

First, where the RA containing cell X is denoted by “RA_X”, the number of UEs in the idle mode that are located in “RA_X” is denoted by “RA_X_NO_UE”, and the number of cells contained in “RA_X” is denoted by “RA_X_NO_CELL”, “NO_UE _X _Y _IDLE” is a resultant value after an “RA_X NO_UE” value is divided by an “RA_X_NO_CELL” value.

After producing the “NO_UE_X_Y” value, the RNC produces “BOW_X_Y” using the above-described “BOW_X_Y” decision method, that is, referring to the above Equation 5, at step 605.

Where a group signaling message to be transmitted through a Uu interface is denoted by a “group signaling message_Uu” 606, the RNC contains the following parameters in the group signaling message_Uu 606 The Uu interface is an interface between UE and UTRAN. Details of Multimedia Broadcast/Multicast Service Architecture and Functional Description state 2 are described in the 3^{rd} Generation Partnership Project (3GPP) Technical Specification (TS) 23.246. The group signaling message_Uu 606 includes a NOTIFICATION message, an MBMS RB SETUP message, etc.

1. The group signaling message_Uu 606 contains typical parameters inserted according to its type and use, for example, an MBMS service identifier and paging cause in the NOTIFICATION message.

2. The group signaling message_Uu 606 contains the “BOW_X_Y” value produced at step 605.

Upon receiving the group signaling message_Uu 606, the UE produces a back-off value using the “BOW_X_Y” value contained therein, and then waits for a time period corresponding to the produced back-off value at step 607. At step 608, the UE begins to perform the RACH transmission operation.

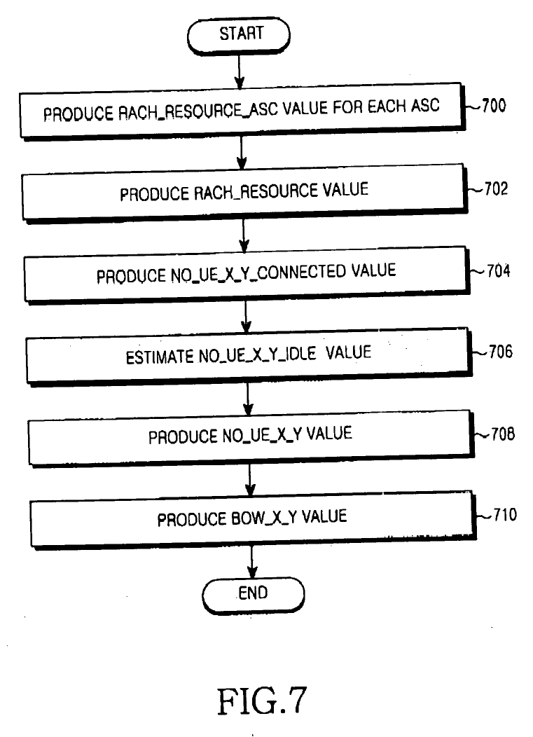

Next, the process for enabling the RNC to produce a “BOW_X_Y” value in accordance with the embodiment of the present invention will be described with reference to FIG. 7. That is, the process for enabling the RNC to decide the “BOW_X_Y” value as shown in FIG. 6 will be described in detail with reference to FIG. 7.

As described above, an “RACH_RESOURCE” value and a “NO_UE_X_Y” value are calculated as two elements necessary for appropriately calculating and determining the “BOW_X_Y” value.

The “RACH_RESOURCE” value indicates the number of currently available RACHs, and the “NO_UE_X_Y” value indicates the number of UEs to make responses through the RACH. Thus, it is preferable that the “BOW_X_Y” value is set so that the “BOW_X_Y” value is directly proportional to the number of UEs and is inversely proportional to the number of RACHs as shown in the above Equation 5.

Referring to FIG. 7, an “RACH_RESOURCE_ASC” value for each ASC is calculated at step 700. At this point, “RACH_RESOURCE_ASC” values are calculated in relation to the sub-channels assigned to all ASCs. Then, the RNC gives weight values to the “RACH_RESOURCE_ASC” values, and calculates a sum of the “RACH_RESOURCE_ASC” values containing the weight values, such that the “RACH_RESOURCE” value is produced at step 702.

In order for the “NO_UE_X_Y” value, being the other element necessary for determining the “BOW_X_Y” value, to be produced, a “NO_UE_X_Y_CONNECTED” value and a “NO_UE_X_Y_IDLE” value are calculated at steps 704 and 706, respectively. Because it is difficult for the “NO_UE_X_Y_IDLE” value to be directly produced, it is preferable that the “NO_UE_X_Y_IDLE” value is estimated using the “RA_NO_UE” value.

At step 708, the “NO_UE_X_Y” value is calculated as the produced “NO_UE_X_Y_CONNECTED” value and the estimated “NO_UE_X_Y_IDLE” value are summed. Consequently, the “BOW_X_Y” value is produced by calculating the above Equation 5 using the produced “RACH_RESOURCE” value and the “NO_UE_X_Y” value at step 710.

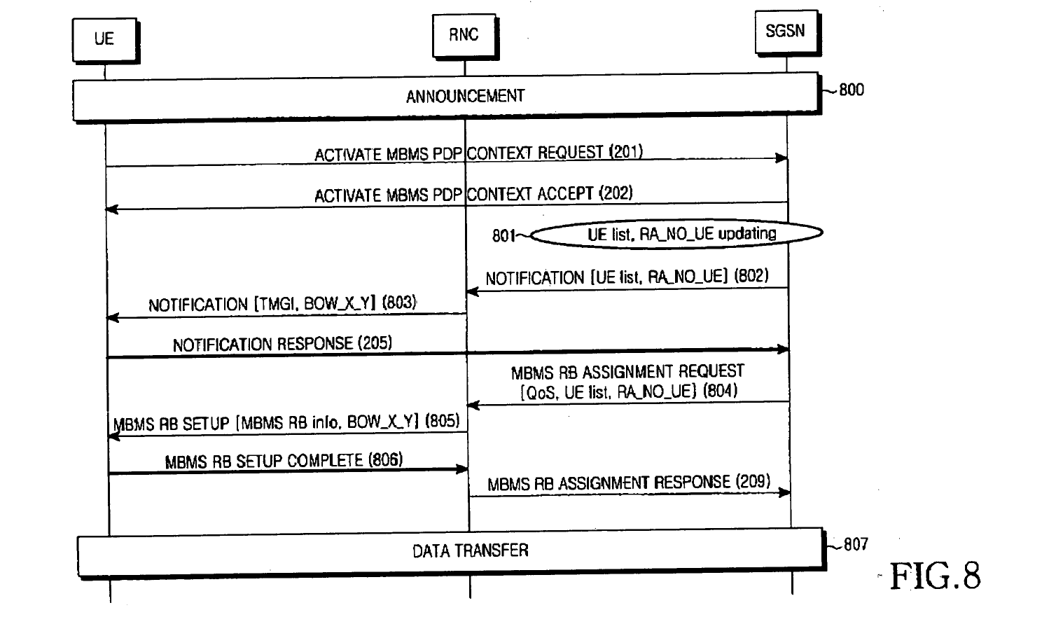

Next, a message exchange operation will be described with reference to FIG. 8. The same reference numerals are given to the same operations shown in FIG. 8 and FIG. 2. Because the same operations have been described with reference to FIG. 2, they will not be described in detail.

At step 800, the core network (CN) performs service announcement to UEs subscribed for the MBMS so that a specific service of the MBMS can be provided. At steps 201 and 202, the SGSN collects ACTIVATE MBMS PDP CONTEXT REQUEST messages for the MBMS service Y from the UEs, and transmits an ACTIVATE MBMS PDP CONTEXT ACCEPT message to the UEs. At step 801, the SGSN updates a UE list and “RA_NO_UE” information on an RNC-by-RNC basis. At step 802, the SGSN transmits a NOTIFICATION message to the RNC. The NOTIFICATION message contains the updated UE list and “RA_NO_UE” information.

At step 803, the RNC refers to the UE list and the “RA_NO_UE” information, produces a “NO UE_X_Y_CONNECTED” value and a “NO_UE_X_Y_IDLE” value, and transmits a NOTIFICATION message through a Uu interface after calculating a “BOW_X_Y” value.

At step 205, the UEs desiring to receive the MBMS service Y produce a back-off value using the “BOW_X_Y” value, wait for a time period corresponding to the produced back-off value and begin to perform an RACH transmission operation, respectively. That is, if an RACH preamble transmission is successful, each UE transmits a NOTIFICATION RESPONSE message.

The SGSN receives NOTIFICATION RESPONSE messages from the UEs, updates a UE list and “RA_NO_UE” information, and transmits an MBMS RB ASSIGNMENT REQUEST message at step 804. Here, the message contains the updated UE list and “RA_NO_UE” information.

When receiving the MBMS RB ASSIGNMENT REQUEST message, the RNC produces a “BOW_X_Y” value as at step 803. The RNC transmits an MBMS RB SETUP message containing the produced “BOW_X_Y” value at step 805. Each UE produces a back-off value using the produced “BOW_X_Y” value, waits for a time period corresponding to the back-off value, and transmits an MBMS RB SETUP COMPLETE message at step 806. The RNC transmits an MBMS RB ASSIGNMENT RESPONSE message to the SGSN at step 209. MBMS data is transferred using the assigned RB at step 807. In accordance with the preferred embodiment of the present invention, “NO_UE_X_Y_CONNECTED” denoting the number of UEs in the connected mode and “NO_UE_X_Y_IDLE” denoting the number of UEs in the idle mode can be initialized by the RNC at steps 802 or 804. After the parameters are initialized, a group signaling message_Iu contains only information different from a previous value in a UE list and an “RA_NO_UE” value. In this case, corresponding parameters are used so that a group signaling message_Iu can be transmitted.

Where uplink messages from a plurality of UEs are transmitted through a random access channel (RACH) or etc. and more particularly in multimedia broadcast/multicast service (MBMS) in which the uplink messages are frequently transmitted through the RACH at the same time in accordance with the present invention, collision and congestion on the RACH, which are destructive and incurable in conventional systems when the uplink messages are simultaneously transmitted can be mitigated.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

What is claimed is:

1. A method for enabling a radio network controller (RNC) to control random accesses of user equipments (UEs) to a mobile communication system when the UEs need to respond to one group signaling message, the mobile communication system including Node-Bs for performing radio communication with the UEs located in a number of cells, the RNC controlling the Node-Bs and a service node (SGSN) connecting the RNC, and transmitting broadcast/multicast service data from the CN to the UEs through the RNC, said method comprising the steps of:
receiving information indicating the number of UEs associated with group signaling from the service node;
when group signaling is required, calculating a back-off window value by referring to the number of UEs, the back-off windows value indicating a back-off range necessary for controlling the random accesses of the UEs; and
containing the calculated back-off window value in a group signaling message and transmitting the group signaling message containing the back-off window value to the UEs.

2. The method as set forth in claim 1, wherein the step of calculating the back-off window value is carried out by referring to the number of UEs and an amount of resources assignable for random access in each cell.

3. The method as set forth in claim 1, further comprising the steps of:
receiving, from the service node, a list of UEs joined in relation to the group signaling and information indicating the number of UEs located in a routing area containing the cells in which the joined UEs are located;
calculating a first value indicating the number of UEs in a connected mode from the UE list;
calculating a second value indicating the number of UEs in an idle mode by dividing the number of UEs located in the routing area by the number of cells contained in the routing area; and
summing the first value and the second value and calculating the number of UEs associated with the group signaling.

4. The method as set forth in claim 2, further comprising the step of:
calculating the resource amount with a number of signatures, a number of access slot sets and persistence values assignable for random access in each cell to transmit the group signaling message.

5. The method as set forth in claim 2, wherein the back-off window value is calculated by dividing the number of UEs by the resource amount and multiplying a result of the division by a predetermined weight value.

6. The method as set forth in claim 1, wherein the group signaling message is a group paging message or a radio bearer setup message for a broadcast/multicast service.

7. A method for enabling user equipments (UEs) to perform random accesses to a mobile communication system when the UEs need to respond to one group signaling message, the mobile communication system including Node-Bs for performing radio communication with the UEs located in a number of cells, a radio network controller (RNC) controlling the Node-Bs and a service node connecting the RNC to a core network (CN), and transmitting broadcast/multicast service data from the CN to the UEs through the RNC, said method comprising the steps of:
receiving the group signaling message containing a predetermined back-off window value determined according to each of the cells in which the UEs are located;
when a response to the group signaling message is required, randomly selecting a back-off value within a range based upon the back-off window value; and
waiting for a time period corresponding to the randomly selected back-off value, and transmitting a response message to the group signaling message through a random access channel.

8. The method as set forth in claim 7, wherein the step of randomly selecting the back-off value is carried out by determining one integer of “0” to the back-off window value having the same selection probability as the back-off value.

9. The method as set forth in claim 7, wherein the group signaling message is a group paging message or a radio bearer setup message for a broadcast/multicast service.

10. A method for enabling random accesses of user equipments (UEs) to be controlled when the UEs need to respond to one group signaling message, in a mobile communication system including Node-Bs for performing radio communication with the UEs located in a number of cells, a radio network controller (RNC) controlling the Node-Bs and a service node connecting the RNC to a core network (CN), and transmitting broadcast/multicast service data from the CN to the UEs through the RNC, said method comprising the steps of:
receiving information indicating the number of UEs associated with group signaling from the service node;
when group signaling is required, referring to the number of UEs contained in the received information, and calculating a back-off window value indicating a back-off range necessary for controlling the random accesses of the UEs;
transmitting a group signaling message containing the calculated back-off window value to the UEs;
allowing the UEs to randomly select a back-off value within a range based upon the back-off window value in response to the group signaling message, respectively; and
allowing the UEs to wait for a time period corresponding to the randomly selected back-off value, and transmitting a response message to the group signaling message to the RNC through a random access channel, respectively.

11. The method as set forth in claim 10, wherein the step of calculating the back-off window value is carried out by referring to the number of UEs contained in the received information and an amount of resources assignable for random access in a specific cell.

12. The method as set forth in claim 10, further comprising the steps of:
allowing the RNC to receive, from the service node, a list of UEs joined in relation to the group signaling and information indicating the number of UEs located in a routing area containing the cells in which the joined UEs are located; and
allowing the RNC to calculate a first value indicating the number of UEs in a connected mode from the UE list, to calculate a second value indicating the number of UEs in an idle mode by dividing the number of UEs located in the routing area by the number of cells contained in the routing area, and to sum the first value and the second value, and to calculate the number of UEs associated with the group signaling.

13. The method as set forth in claim 11, further comprising the step of:
allowing the RNC to calculate the resource amount with a number of signatures, a number of access slot sets and persistence values assignable for random access in each cell to transmit the group signaling message.

14. The method as set forth in claim 11, wherein the back-off window value is calculated by dividing the number of UEs by the resource amount and multiplying a result of the division by a predetermined weight value.

15. The method as set forth in claim 10, wherein the step of randomly selecting the back-off value is carried out by determining one integer of “0” to the back-off window value having the same selection probability as the back-off value.

16. The method as set forth in claim 10, wherein the group signaling message is a group paging message or a radio bearer setup message for a broadcast/multicast service.

17. A method for enabling random accesses of user equipments (UEs) to be controlled when the UEs need to respond to one group signaling message, in a mobile communication system including Node-Bs for performing radio communication with the UEs located in a number of cells, a radio network controller (RNC) controlling the Node-Bs and a service node connecting the RNC to a core network (CN), and transmitting broadcast/multicast service data from the CN to the UEs through the RNC, said method comprising the steps of:
allowing the service node to update a list of UEs in a connected mode joined in a service requiring group signaling and the number of UEs in an idle mode joined in a service requiring group signaling on a routing area-by-routing area basis; and
transmitting a group signaling request message from the service node to the RNC so that a group signaling request requiring a response can be made, the group signaling request message containing the UE list and information indicating the number of UEs on the routing area-by-routing area basis.

18. The method as set forth in claim 17, further comprising the step of:
allowing the RNC to refer to the UE list and the number of UEs on the routing area-by-routing area basis, to calculate a back-off window value indicating a back-off range for the random accesses of the UEs, to contain the calculated back-off window value in a group signaling message, and to transmit the group signaling message containing the calculated back-off window value.

19. The method as set forth in claim 17, further comprising the step of:
allowing the RNC to calculate a first value indicating the number of UEs in a connected mode from the UE list, to calculate a second value indicating the number of UEs in an idle mode by dividing the number of UEs located in the routing area by the number of cells contained in the routing area, and to sum the first value and the second value, and to calculate the number of UEs associated with the group signaling.

20. The method as set forth in claim 19, further comprising the steps of:
allowing the RNC to calculate an amount of resources with a number of signatures, a number of access slot sets and persistence values assignable for random access in each cell to transmit the group signaling message, and to calculate the back-off window value by dividing the number of UEs by the resource amount and multiplying a result of the division by a predetermined weight value.

21. The method as set forth in claim 17, further comprising the steps of:
allowing the UEs to randomly select a back-off value within a range based upon the back-off window value in response to the group signaling message, respectively; and
allowing the UEs to wait for a time period corresponding to the randomly selected back-off value, and to transmit a response message to the group signaling message to the RNC through a random access channel, respectively.

22. The method as set forth in claim 21, wherein the UEs determine one integer of “0” to the back-off window value having the same selection probability as the back-off value, respectively.

23. The method as set forth in claim 21, wherein the UEs wait for a time period corresponding to the number of radio frames of the selected back-off value, respectively, before response messages are transmitted.

24. The method as set forth in claim 18, wherein the group signaling message is a group paging message or a radio bearer setup message for a broadcast/multicast service.
